(19) United States
(12) Patent Application Publication
(10) Pub. No.: US 2022/0386645 A1
(43) Pub. Date: Dec. 8, 2022

(54) GUMMY CHEW PRODUCTS AND USES THEREOF

(71) Applicant: TURNARY USA, LLC, Naples, FL (US)

(72) Inventor: John A. Parker, Naples, FL (US)

(21) Appl. No.: 17/828,504

(22) Filed: May 31, 2022

Related U.S. Application Data
(60) Provisional application No. 63/196,275, filed on Jun. 3, 2021.

(51) Int. Cl. A23G 4/14; A23G 4/06; A23G 4/10

(52) U.S. Cl. CPC A23G 4/14; A23G 4/064; A23G 4/10; A23V 2002/00

(57) ABSTRACT

A gummy chew product comprising at least one branched chain amino acid (BCAA), theanine, alpha-glycerophosphocholine (alpha-GPC), and at least one mineral. The gummy chew product is suitable for use in improving muscle function and recovery, providing cognitive enhancement, and/or replenishing lost electrolytes in individuals when consumed before, during, and/or after physical and/or mental activity. Servings of from 50 to 150 grams of the gummy chew product in a plurality of pieces may be contained in a package with the gummy chew product sealed therein.

### CROSS-REFERENCE TO RELATED APPLICATION

Pursuant to 35 U.S.C. § 119(e), this U.S. non-provisional application, filed pursuant to 35 U.S.C. § 111(a), claims the benefit of U.S. Provisional Patent Application Ser. No. 63/196,275, filed Jun. 3, 2021, which is incorporated herein by reference in its entirety.

### FIELD

The present disclosure relates generally to gummy chew products advantageous for providing performance-, strength-, recovery-, and/or cognitive-enhancing additives to an individual prior to, during, and/or after physical and/or mental activities.

### BACKGROUND

Individuals who participate in physical activities, e.g., weightlifting and/or strength training, often find it desirable to supplement their diet prior to, during, and/or after a workout to consume certain performance-, strength- and/or recovery-enhancing supplements prior to, during, or after such activities. There are a number of dietary supplements for improving workout recovery and/or enhancing workout performance. Such dietary supplements are typically administered in the form of powders or pre-made drinks. However, these forms of administration are often inconvenient, particularly when a user wishes to ingest the supplements on the go and/or while they are actively participating a physical or mental activity. For example, administering dietary supplements via powdered mixes requires a number of time-consuming steps, including measuring the desired amount of powdered product, providing a liquid medium for reconstituting the powder, providing a cup or other suitable mixing device, and thereafter combining and mixing the ingredients. Not only does this require the user to travel with and keep each of these components readily available, but they must also set aside time to make the reconstituted beverage.

Regarding pre-made drinks, it becomes difficult to keep these products chilled over an extended period of time. Keeping beverages chilled becomes particularly difficult when exercising outside, or when participating in physical activities in a gym or other exercise facility that lacks a refrigeration unit. Further, powdered mixes and pre-made drinks typically exhibit undesirable mouthfeel and taste. Dietary supplement bars, e.g., protein bars, are an alternative to existing powders and pre-made drinks, however dietary supplement bars also typically exhibit undesirable taste and many contain large amounts of added sugars.

Similarly, individuals participating in mental activities, e.g., video gaming or studying, often find it desirable to consume supplements which are able to provide various cognitive benefits. The same is true for individuals participating in physical activities. Examples of such benefits include improvements in memory, increased mental alertness and/or concentration, and/or increased energy levels. Accordingly, there remains a continuing need for products which allow individuals to consume such supplements easily and conveniently in a quick, convenient, and appetizing manner prior to, during, and/or after such physical activities and/or mental activities.

### Embodiments

In addition to other advantages, the gummy chew product of the present invention is advantageous for easily and conveniently providing performance-, strength-, recovery-, and/or cognitive enhancing additives to individuals prior to, during, and/or following physical and/or mental activities. The gummy chew product of the present invention serves to provide an individual with a tasty, quick, and convenient way to prepare the body for a physical and/or mental activity, replenish lost nutrients during and/or following physical and/or mental activity, and/or assist in recovery following physical and/or mental activity. As such, the convenient, easily administrable, low calorie, and appetizing dietary supplement for providing performance-, strength-, recovery-, and/or cognitive-enhancing additives, that is the gummy chew product of the present invention is highly desirable. The gummy chew product of the present invention provides a convenient snack which can be administered to an individual before, during, and/or after physical and/or mental activities. The gummy chew product of the present invention is easily transportable, mess-free, and convenient, and provides a quick and effective way to prepare the individual's body for physical and/or mental training, replenish lost nutrients during and/or following physical and/or mental activities, and/or assist in recovery following physical and/or mental activities.

An aspect of the present invention is a gummy chew product comprising a gummy matrix, at least one branched chain amino acid (hereinafter, “BCAA”), theanine, alpha-glycerophosphocholine (hereinafter, “alpha-GPC”), and at least one mineral.

In certain embodiments, the at least one BCAA comprises leucine, isoleucine, or a combination thereof. In certain embodiments, the at least one mineral comprises sodium, potassium, or a combination thereof. In certain embodiments, the at least one BCAA comprises isoleucine and leucine, and the at least one mineral comprises sodium and potassium. In certain embodiments, the gummy matrix comprises a natural sweetener, a gelling agent, and water. In certain embodiments, the gummy matrix comprises pectin. In certain embodiments, the gummy matrix comprises a sugar alcohol. In certain embodiments, the sugar alcohol comprises maltitol, sorbitol, or a combination thereof. In certain embodiments, the gummy matrix further comprises an acidity regulator. In certain embodiments, the acidity regulator comprises malic acid, citric acid, or a combination thereof. In certain embodiments, the gummy chew product further comprises at least one component selected from the group consisting of flavorants, colorants, glazing agents, and any combination thereof. In certain embodiments, the gummy chew product further comprises a colorant, wherein the colorant comprises carmine. In certain embodiments, the gummy chew product further comprises a glazing agent, wherein the glazing agent comprises carnauba wax, vegetable oil, or a combination thereof. In certain embodiments, the gummy chew product further comprises potassium citrate. In certain embodiments, the gummy chew product further comprises sodium citrate, sodium chloride, or a combination thereof.

In certain embodiments, the combined weight of the at least one BCAA, theanine, alpha-GPC, and at least one mineral comprises up to about 10% by weight of the total weight of the gummy chew product. In certain embodiments, the at least one BCAA is present in an amount of from about 0.1 to about 4% by weight, the at least one mineral is present in an amount of from about 0.01 to about 3% by weight, the theanine is present in an amount of from about 0.01 to about 0.45 by weight, and the alpha-GPC is present in an amount of from about 0.01 to about 1% by weight, all based on the total weight of the gummy chew product. In certain embodiments, the potassium, sodium, theanine, isoleucine, leucine, and alpha-GPC are present in an amount of up to about 10% by weight combined and the gummy matrix is present in an amount of from about 90 to about 99% by weight, all based on the total weight of the gummy chew product. In certain embodiments, the potassium is present in an amount of from about 0.01 to about 1% by weight, the sodium is present in an amount of from about 0.01 to about 1% by weight, the alpha-GPC is present in an amount of from about 0.2 to about 0.8% by weight, the isoleucine is present in an amount of from about 0.01 to about 1% by weight, the leucine is present in an amount of from about 0.1 to about 2% by weight, and the theanine is present in an amount of from about 0.01 to about 0.2% by weight, all based on the total weight of the gummy chew product. In certain embodiments, per 2 gram serving of the gummy chew product, potassium is present in an amount of from about 2 to about 15 mg, sodium is present in an amount of from about 2 to about 15 mg, alpha-GPC is present in an amount of from about 5 to about 15 mg, isoleucine is present in an amount of from about 15 to about 25 mg, leucine is present in an amount of from about 30 to about 50 mg, and theanine is present in an amount of from about 1 to about 5 mg.

Another aspect of the present invention is a packaged product comprising a sealed package and a serving of the gummy chew product of the present invention contained within the sealed package, wherein the serving of the gummy chew product is present in an amount in the range of from 50 to 150 grams and wherein the gummy chew product comprises a plurality of pieces. In certain embodiments, the serving of the gummy chew product provides no more than 400 calories per 100 grams of gummy chew product.

Another aspect of the present invention is a method of improving muscle function and recovery in an individual before, during, or after a physical activity, comprising administering the gummy chew product of the present invention to the individual before the physical activity, during the physical activity, or after the physical activity. In certain embodiments, the gummy chew product is administered to the individual at least 30 minutes before the physical activity. In certain embodiments, the gummy chew product is administered to the individual within 1 hour after the physical activity is completed.

Another aspect of the present invention is method of providing cognitive enhancement in an individual before, during, or after a physical or mental activity, comprising administering the gummy chew product of the present invention before the physical or mental activity, during the physical or mental activity, or after the physical or mental activity. In certain embodiments, the gummy chew product is administered to the individual at least 30 minutes before the physical activity. In certain embodiments, the gummy chew product is administered to the individual within 1 hour after the physical activity is completed.

Another aspect of the present invention is method of replenishing lost electrolytes comprising administering the gummy chew product of present invention to an individual in need thereof.

Additional aspects and advantages of the various embodiments of the present invention will be further described herein.

### DETAILED DESCRIPTION

Specific embodiments of the present invention are described herein. The present invention can, however, be embodied in different forms and should not be construed as limited to the embodiments set forth herein. Rather, these embodiments are provided to illustrate more specific features of certain aspects of the invention to those skilled in the art.

The terminology as set forth herein is for description of the embodiments only and should not be construed as limiting the disclosure as a whole. All references to singular characteristics or limitations of the present disclosure shall be construed to include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and appended claims, the singular forms “a,” “an,” and “the” are inclusive of their plural forms, unless the context clearly indicates otherwise.

To the extent that the term “includes” or “including” is used in the description or the claims, it is intended to be inclusive of additional elements or steps, in a manner similar to the term “comprising” as that term is interpreted when employed as a transitional word in a claim. Furthermore, to the extent that the term “or” is employed (e.g., “A or B”), it is intended to mean “A or B or both.” When the “only A or B but not both” is intended, then the term “only A or B but not both” is employed. Thus, use of the term “or” herein is the inclusive, and not the exclusive, use. When the term “and” as well as “or” are used together, as in “A and/or B” this indicates A or B as well as A and B.

The methods and products described in the present disclosure can comprise, consist of, or consist essentially of any of the elements and steps as described herein.

All ranges and parameters, including but not limited to percentages, parts, and ratios disclosed herein are understood to encompass and express disclose herein any and all sub-ranges subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

Any combination of method or process steps as used herein can be performed in any order, unless otherwise specified or clearly implied to the contrary by the context in which the referenced combination is made.

All percentages are percentages by weight unless otherwise indicated.

The term “physical activity” as used herein, unless otherwise specified, refers to as any bodily movement that requires energy expenditure. Physical activity encompasses all activities, at any intensity. Examples of physical activities include, but are not limited to, running, biking, walking, weightlifting, strength training, rowing, and swimming.

The term “mental activity” as used herein, unless otherwise specified, refers to anything that stimulates, activates, or enriches the mind. Stimulation can be provided internally from thought or externally from the environment.

The term “improving muscle function” as used herein, unless otherwise specified, refers to improving muscle strength, muscular endurance, flexibility, muscle power, and/or muscle mass. Muscle strength is defined as the amount of force that a muscle can produce in a single effort. Muscular endurance is defined as the ability of a muscle to exert force against resistance over time. Flexibility is defined as the range of movement in a joint or series of joints, and length in muscles that cross the joints to induce a bending movement or motion. Muscle power is defined as the ability of the muscle to exert a maximal force in as short a time as possible. Muscle mass is defined as the weight of the muscles in the body and includes smooth muscles, skeletal muscles, and water contained in the muscles.

The term “improving muscle recovery” as used herein, unless otherwise specified, refers to reducing muscle loss, decreasing muscle fatigue, and/or reducing or alleviating muscle soreness.

The terms “cognitive enhancement” or “cognitive-enhancing” as used herein, unless otherwise specified, refers to improvements in memory, increased mental alertness and concentration, and/or increased energy levels and wakefulness.

One aspect of the present invention is directed to gummy chew products suitable for use in improving muscle function and recovery, providing cognitive enhancement, and/or replenishing lost electrolytes in individuals when consumed before, during, and/or after physical and/or mental activity. The gummy chew products of the present invention comprise (1) a gummy matrix, (2) at least one BCAA. (3) theanine, (4) alpha-GPC, and (5) at least one mineral.

The gummy chew product of the present invention comprises at least one BCAA. BCAAs, i.e., isoleucine, leucine, and valine, are essential amino acids that cannot be produced by the body in physiologically significant amounts. BCAAs must therefore come from an individual's diet, e.g., through protein-rich foods or supplements. BCAAs have been shown to yield several benefits, including, inter alia, stimulating muscle protein synthesis, decreasing muscle soreness following physical activity, reducing exercise fatigue, and reducing muscle breakdown. However, BCAA supplements are primarily sold in powder form, which must be mixed with water, as discussed supra, in pre-made sports drinks or other similar beverages, or they are administered as tablets. It is therefore difficult to administer BCAAs in a quick and convenient way, particularly when an individual is actively participating in physical activity. A convenient method of administration, like the gummy chew product of the present invention, is therefore desirable.

In certain embodiments, the at least one BCAA in the gummy chew product of the present invention comprises isoleucine, leucine, or a combination thereof. In certain embodiments, the BCAA comprises both isoleucine and leucine. In certain embodiments, the isoleucine and leucine are 1-isoleucine and 1-leucine.

While the relative amounts of the at least one BCAA in the gummy chew product of the present invention may vary, in certain embodiments the gummy chew product comprises from about 0.01 to about 5% by weight, from about 0.01 to about 4% by weight, from about 0.01 to about 3% by weight, from about 0.01 to about 2% by weight, from about 0.01 to about 1% by weight, from about 0.1 to about 4% by weight, from about 0.1 to about 3% by weight, from about 0.1 to about 2% by weight, or from about 0.1 to about 1% by weight of the at least one BCAA, based on the total weight of the gummy chew product. In certain embodiments, the gummy chew product comprises from about 0.1 to about 4% by weight of the at least one BCAA. In certain embodiments, the gummy chew product comprises at least about 3% by weight of the at least one BCAA.

In certain embodiments, the gummy chew product of the present invention comprises from about 0.1 to about 2% by weight, from about 0.1 to about 1% by weight, or from about 0.1 to about 0.5% by weight leucine and from about 0.01 to about 1% by weight, from about 0.01 to about 0.5% by weight, or from about 0.01 to about 0.2% by weight isoleucine, based on the total weight of the gummy chew product. In certain embodiments, the gummy chew product of the present invention comprises from about 0.1 to about 2% by weight leucine and from about 0.01 to about 1% by weight isoleucine, based on the total weight of the gummy chew product.

The gummy chew product of the present invention comprises theanine. Without wishing to be bound to any particular theory, studies suggest that theanine may be helpful for inducing relaxation and reducing anxiety, thus imparting various cognitive benefits which may be useful, for example, for individuals participating in various mental activities, for example studying or video gaming. The inclusion of theanine in the gummy chew product of the invention is therefore desirable.

While the relative amounts of theanine in the gummy chew product of the present invention may vary, in certain embodiments the gummy chew product comprises from about 0.01 to about 1% by weight, from about 0.01 to about 0.8% by weight, from about 0.01 to about 0.6% by weight, from about 0.01 to about 0.4% by weight, or from about 0.01 to about 0.2% by weight of theanine, based on the total weight of the gummy chew product.

The gummy chew product of the present invention advantageously includes alpha-GPC. Alpha-GPC is a natural choline compound found in the brain and, without wishing to be bound to any particular theory, has been suggested to provide both physical and cognitive benefits. For example, some studies have indicated that alpha-GPC increases acetylcholine in the brain, which is important for both memory and learning functions. Some studies have also shown that alpha-GPC supplementation prevents exercise-induced reductions in choline levels, increases endurance performance, and increases growth hormone secretion. As such, it is useful to provide a convenient food product containing alpha-GPC in order to impart these benefits, wherein the product can be administered to individuals before, during, and/or after partaking in physical and/or mental activities. Examples of such activities include, but are not limited to, running, weightlifting, bodybuilding, reading, studying, and video gaming.

While the relative amounts of alpha-GPC in the gummy chew product of the invention may vary, in certain embodiments the gummy chew product comprises from about 0.01 to about 1.2% by weight, from about 0.01 to about 1.1% by weight, from about 0.01 to about 1% by weight from about 0.01 to about 0.9% by weight, from about 0.01 to about 0.8% by weight, from about 0.01 to about 0.7% by weight, from about 0.01 to about 0.6% by weight, from about 0.01 to about 0.5% by weight, from about 0.01 to about 0.4% by weight, from about 0.01 to about 0.3% by weight, from about 0.01 to about 0.2% by weight, or from about 0.01 to about 0.1% by weight of alpha-GPC, based on the total weight of the gummy chew product. In certain embodiments, the gummy chew product comprises from about 0.2 to about 0.8% by weight alpha-GPC. In certain embodiments, the gummy chew product comprises at least 0.5% by weight alpha-GPC. Any of the foregoing amounts of alpha-GPC are suitable for use in the gummy chew products of the present invention. In certain embodiments, the total amount of alpha-GPC administered to an individual does not exceed the current daily recommended dosage of 1200 mg.

The gummy chew product of the present invention comprises at least one mineral. While any suitable mineral supplement(s) may be included in the gummy chew product of the present invention, in certain embodiments, the gummy chew product comprises sodium, potassium, or a combination thereof. In certain embodiments, the source of the sodium may be, and thus the gummy chew product may comprise, sodium citrate, sodium chloride, or a combination thereof. In certain embodiments, the source of the potassium may be, and thus the gummy chew product may comprise, potassium citrate.

Sodium is both an electrolyte and a mineral and may be useful to include in the gummy chew product of the present invention for purposes of treating or preventing sodium loss as a result of dehydration and/or excess sweating, both of which can occur as a result of physical activity. Furthermore, sodium has known benefits, some of which include maintaining blood pressure, absorbing and transporting nutrients, and maintaining adequate fluid balance. In addition to the foregoing benefits, sodium, and more specifically sodium citrate, may be useful as a pH buffer for enhancing the flavor profile of the gummy chew product of the present invention.

Potassium is also both an electrolyte and a mineral and is useful for, inter alia, regulating heartbeat and blood pressure, glycogen synthesis, and is also involved in the electrical signals sent by muscles. As potassium allows muscles to contract properly, potassium consumption is important for preventing muscle weakness and muscle cramping. This is particularly important for individuals participating in physical activity. In addition to the foregoing benefits, potassium, and more specifically potassium citrate, may also be useful as a pH buffer or for enhancing the flavor profile of the gummy chew product of the present invention.

While the relative amount of the at least one mineral in the gummy chew product of the present invention may vary, in certain embodiments the gummy chew product comprises from about 0.01 to about 5% by weight, from about 0.01 to about 4% by weight, from about 0.01 to about 3% by weight, from about 0.01 to about 2% by weight, from about 0.01 to about 1% by weight, from about 0.1 to about 5% by weight, from about 0.5 to about 3% by weight, from about 0.5 to about 2% by weight, or from about 0.5 to about 1.5% by weight of the at least one more mineral, based on the total weight of the gummy chew product. In certain embodiments, the gummy chew product comprises from about 0.01 to about 3% by weight of the at least one mineral. In certain embodiments, the gummy chew product comprises from about 0.01 to about 2% by weight, or from about 0.01 to about 1% by weight sodium and from about 0.01 to about 2% by weight, or from about 0.01 to about 1% by weight potassium, based on the total weight of the gummy chew product. In certain embodiments, the gummy chew product comprises from about 0.1 to about 0.6% by weight sodium and from about 0.1 to about 0.6% by weight potassium, based on the total weight of the gummy chew product.

In certain embodiments, the gummy chew product of the present invention comprises isoleucine, leucine, sodium, and potassium. In certain embodiments, the gummy chew product comprises from about 0.01 to about 1% by weight potassium, from about 0.01 to about 1% by weight sodium, from about 0.2 to about 0.8% by weight alpha-GPC, from about 0.01 to about 1% by weight isoleucine, from about 0.1 to about 2% by weight leucine, and from about 0.01 to about 0.2% by weight theanine, based on the total weight of the gummy chew product.

Without wishing to be bound to any particular theory, the combination of at least one BCAA, theanine, alpha-GPC, and at least one mineral, and, in particular, the combination of isoleucine, leucine, theanine, alpha-GPC, sodium, and potassium, in the gummy chew product of the present invention provides a quick and effective way to improve overall workout performance and improve workout recovery. More specifically, the combination of the foregoing ingredients provides an effective way to replenish electrolytes, repair muscle damage, and promote muscle growth. Furthermore, this novel combination of ingredients provides an effective way to achieve the above mentioned benefits, while at the same time improving energy, reducing stress, and increasing mental alertness and concentration.

The gummy chew product of the present invention comprises a gummy matrix. Generally, gummy matrices are soft solid materials and are known in the art to typically comprise sugar, a gelling agent, and residual moisture from the manufacturing process. In certain embodiments of the gummy chew product of the present invention, the gummy matrix comprises a gelling agent, a natural sweetener, water, and optionally an acidity regulator.

Sugars/sweeteners normally represents the largest component of gummy chew products. Although any suitable sugars/sweeteners may be employed in the gummy matrix of the gummy chew product of the present invention, the gummy matrix advantageously employs natural sweeteners. In certain embodiments, the natural sweetener comprises a sugar alcohol. In certain embodiments, the sugar alcohol comprises maltitol, sorbitol, or a combination thereof.

A gelling agent is employed in the gummy chew products of the present invention to assist in providing a stable, soft, and solid final product. During traditional gummy chew product manufacture, various raw ingredients, such as water, sugar(s)/sweetener(s), flavor(s), and color(s), are first mixed together. The resulting liquid mixture is then mixed with a gelling agent. The liquid mixture is then cooked and thickened into a slurry, which is poured into starch-coated molds for shaping the gummy chew product. The gummy chew product is allowed to cool and then removed from the mold.

Various gelling agents are known in the art and may be used in the gummy matrix of the gummy chew product of the present invention, alone or in combination, so long as the gelling agent is employed in an amount effective to provide a soft solid form to the gummy chew product. Examples of gelling agents (which are also thickening components) useful in the gummy matrix of the gummy chew product of the present invention include, but not limited to, gelatin, gellan gum, xanthan gum, pectin, carrageenan, cellulose gum, gum arabic, modified starch, and combinations thereof. In certain embodiments, the gelling agent comprises pectin.

In certain embodiments, the gummy matrix of the gummy chew product of the present invention further comprises an acidity regulator to assist with optimal gelation. Examples of suitable food grade acidity regulators include, but are not limited to, ascorbic acid, citric acid, malic acid, and/or lactic acid. One or more acidity regulators may be included in functional amounts as desired. In certain embodiments, the gummy chew product comprises malic acid, citric acid, or a combination thereof.

While the relative amounts of the gummy matrix, the at least one BCAA, theanine, alpha-GPC, and at least one mineral may vary, in certain embodiments the at least one BCAA, theanine, alpha-GPC, and at least one mineral combined comprise up to about 10% by weight of the total weight of the gummy chew product of the present invention. In certain embodiments, the gummy chew product comprises from about 0.1 to about 4% by weight of the at least one BCAA, from about 0.01 to about 3% by weight of the one or more minerals, from about 0.01 to about 0.4% by weight of theanine, and from about 0.01 to about 1% by weight alpha-GPC, all based on the total weight of the gummy chew product. In certain embodiments, the gummy chew product comprises up to about 10% by weight of potassium, sodium, theanine, isoleucine, leucine, and alpha-GPC combined and from about 90 to about 99% by weight of the gummy matrix.

The gummy chew product of the present invention optionally further comprises at least one additional excipient. In certain embodiments, the gummy chew product optionally further comprises a flavorant, a colorant, a glazing agent, or any combination thereof.

In certain embodiments, the gummy chew product of the present invention optionally further comprises at least one natural and/or artificial flavorant. Such ingredients include those known in the art as flavorants and may be employed herein as desired to achieve any desired flavor profile. Examples of such flavorant include, but are not limited to, natural and/or artificial fruit flavors, such as watermelon, lemon, orange, lime, grapefruit, apple, pear, peach, grape, blueberry, strawberry, raspberry, cherry, plum, pineapple, apricot, banana, melon, apricot, cherry, raspberry, blackberry, tropical fruit, mango, pomegranate, or combinations thereof. In certain embodiments, the flavorant comprises a natural and/or artificial watermelon fruit flavor.

In certain embodiments, the gummy chew product of the present invention optionally further comprises a colorant for providing the gummy chew product with a desired visual effect, for example to provide the gummy chew product with a color which corresponds to a particular flavor. Such ingredients are known in the art and may be employed herein as desired to achieve the desired coloring. Although the colorant may be any suitable coloring agent, in certain embodiments, the gummy chew product comprises a natural colorant. Examples of such natural colorants include, but are not limited to, annatto, caramel coloring, carmine, dactylopius coccus, elderberry juice, lycopene, paprika, turmeric, curcumin, or combinations thereof. In certain embodiments, the colorant comprises carmine.

In certain embodiments, the gummy chew product of the present invention optionally further comprises a glazing agent. Glazing agents are natural or synthetic substances which may be used to provide a waxy, homogeneous, coating to prevent water loss from the surface of the gummy chew product, to impart a shine to the surface of the gummy chew product, and/or to prevent stickiness. Such ingredients are known in the art and may be employed herein as desired. In certain embodiments, the gummy chew product comprises carnauba wax, vegetable oil, or a combination thereof.

In certain embodiments, the gummy chew product of the present invention optionally further comprises further ingredients, examples of which include, but are not limited to, vitamins or related nutrients, non-limiting examples of which include Vitamin A, Vitamin B12, Vitamin C, Vitamin D, Vitamin K, thiamine, riboflavin, pyridoxine, niacin, folic acid, pantothenic acid, biotin, choline, inositol, salts and derivatives thereof, and combinations thereof, and minerals, non-limiting examples of which include calcium, phosphorus, magnesium, zinc, manganese, molybdenum, chromium, chloride, and combinations thereof, and the like.

The gummy chew product of the present invention may be formed in any desired shape or size. In certain embodiments, the gummy chew product is in the form of bite-size pieces, i.e., less than about 2 inches, or less than about 1.5 inches, or about 1 inch, in diameter or in each of its length and width dimensions, so that a piece of the gummy chew product may be easily consumed in a single bite during exercise. In certain embodiments, examples of suitable shapes include, but are not limited to, those with circular, square, rectangular, triangular, trapezoidal, pentagonal, or hexagonal cross-sections, and with a thickness of from about 0.25 to 1 inch. In certain embodiments, a bite-size piece of the gummy chew product of the present invention suitably has a weight of from about 1 to 10 grams, more specifically from about 1 to 5 grams, and more specifically from about 1 to about 3 grams. In certain embodiments, the gummy chew product has a weight of about 2 grams.

In certain embodiments, the gummy chew product of the present invention has a weight of 2 grams and comprises from about 2 to about 15 mg potassium, from about 2 to about 15 mg sodium, from about 5 to about 15 mg alpha-GPC, from about 15 to about 25 mg isoleucine, from about 30 to about 50 mg leucine, and from about 1 to about 5 mg theanine. In certain embodiments, the gummy chew product has a weight of 2 grams and comprises from about 3 to about 11 mg potassium, from about 2 to about 15 mg sodium, from about 9 to about 11 mg alpha-GPC, from about 19 to about 22 mg isoleucine, from about 38 to about 43 mg leucine, and from about 2 to about 4 mg theanine.

Another aspect of the present invention is directed to methods of improving muscle function and recovery in an individual before, during, or after physical activity. The method comprises administering the gummy chew product of the present invention to the individual before physical activity, during physical activity, or after physical activity. In certain embodiments, the gummy chew product of the present invention is administered to the individual at least 30 minutes before the physical activity.

Another aspect of the present invention is directed to methods of providing cognitive enhancement in an individual before, during, or after a physical and/or mental activity. The method comprises administering the gummy chew product of the present invention before physical and/or mental activity, during physical and/or mental activity, or after physical and/or mental activity. In certain embodiments, the gummy chew product of the present invention is administered to the individual at least 30 minutes before the physical and/or mental activity.

Electrolyte imbalance manifests in a number of different ways, including irregular heartbeat, fatigue, nausea, vomiting, diarrhea, and/or constipation. Given that water and electrolytes are lost through sweat, individuals participating in physical activities, such as running, weightlifting, and/or strength training, are particularly prone to electrolyte imbalance and its complications. As such, it is desirable to have the ability to quickly replenish electrolytes during and/or after physical activity. As such, another aspect of the present invention is directed to methods of replenishing electrolytes in an individual, comprising administering the gummy chew product of the present invention to an individual in need thereof. In certain embodiments, the gummy chew product of the present invention is administered to an individual within 1 hour after the physical and/or mental activity is completed.

Another aspect of the present invention is directed to packaged products comprising a package (e.g., a packet) containing a plurality of the gummy chew product of the present invention. In certain embodiments, the packaged product comprises a plurality of bite-size pieces of the gummy chew product of the present invention in a package. In certain embodiments, the packaged product contains 20 or more individual pieces of gummy chew product. In certain embodiments, the packaged product contains from about 20 to about 70 individual pieces of gummy chew product. In certain embodiments, the packaged product contains about 50 individual pieces of gummy chew product. In certain embodiments, a 100 gram serving of the gummy chew product of the present invention comprises a plurality of pieces. In certain embodiments, a 100 serving of the gummy chew product of the present invention comprises about 50 bite-size pieces. In certain embodiments, the product comprises not more than 400 calories per serving of 100 grams of the gummy chew product of the present invention. In certain embodiments, the product comprises not more than 350 calories per serving of 100 grams of the gummy chew product of the present invention.

The package employed in the packaged product of the present invention may be of any desirable form and material. In certain embodiments, the package is a packet which is sealable and the packaged product is sealed to limit air entering into the package. In certain embodiments, the packet is sealable to provide a substantially air-tight seal, preventing air from entering the package during the shelf-life of the packaged product. The packet may be flexible or rigid and may suitably be formed of metal foil, plastic, or a combination of plastic and metal foil, or any of these in combination with paper. In certain embodiments, the packaged product comprises a serving of the gummy chew product of the present invention. Alternatively, multiple pieces of the gummy chew product of the present invention may be packaged in a multiple serving container, for example, a box, a jar, or the like.

The foregoing description and the claims will be more readily understood by referring to the following non-limiting example of the present invention, which is given to illustrate certain specific embodiments thereof rather than limit its scope. While the following non-limiting example illustrates certain specific embodiments of the present invention, it will be apparent and manifest to, and envisioned by, persons of ordinary skill in the art reading this description that various modifications, rearrangements, changes, and variations may be made thereto without departing from the spirit and scope of the underlying present invention and that the same is not limited to the particular embodiments shown and described herein. In other words, the following example is not intended to be exhaustive in scope, but rather is encompassed within the spirit and scope of the present invention and, thus, the present invention should not be construed as limited to the following embodiment.

### Example

The following ingredients are mixed together:

| | Weight |
|---|---|
| Ingredient | (milligrams) |
| Potassium citrate | 11.0 |
| Sodium citrate and Sodium chloride | 12.0 |
| Alpha-GPC | 10.6 |
| L-Isoleucine | 21.0 |
| L-Leucine | 42.0 |
| L-Theanine | 3.15 |
| Maltitol Solution | 806.3 |
| Maltitol | 635.3 |
| Purified Water | 280.0 |
| Sorbitol | 80.6 |
| Citric Acid | 18.6 |
| DL-Malic Acid | 9.3 |
| Watermelon Flavor 1 | 10.8 |
| Watermelon Flavor 2 | 6.5 |
| Cochineal | 0.34 |

The resulting liquid mixture is then mixed with 47.3 mg of pectin (i.e., gelling agent). The liquid mixture is then cooked and thickened into a slurry, which is then poured into starch-coated, drop-shaped, molds for shaping. The incipient product is allowed to cool, then removed from the mold, and glazed with a mixture of carnauba wax and vegetable oil (4.5 mg). The resulting drop shape, watermelon flavor gummy chew product according to the present invention has a weight of 2000 mg (+/−10%) and contains a minimum of 4 mg potassium, 4 mg sodium, 10 mg Alpha-GPC, 20 mg L-isoleucine, 40 mg L-leucine, and 3 mg L-theanine.

1. A gummy chew product comprising a gummy matrix, at least one BCAA, theanine, alpha-GPC, and at least one mineral.

2. The gummy chew product of claim 1, wherein the combined weight of the at least one BCAA, theanine, alpha-GPC, and at least one mineral comprises up to about 10% by weight of the total weight of the gummy chew product.

3. The gummy chew product of claim 1, wherein the at least one BCAA comprises leucine, isoleucine, or a combination thereof.

4. The gummy chew product of claim 1, wherein the at least one mineral comprises sodium, potassium, or a combination thereof.

5. The gummy chew product of claim 1, wherein the at least one BCAA is present in an amount of from about 0.1 to about 4% by weight, the at least one mineral is present in an amount of from about 0.01 to about 3% by weight, the theanine is present in an amount of from about 0.01 to about 0.45 by weight, and the alpha-GPC is present in an amount of from about 0.01 to about 1% by weight, all based on the total weight of the gummy chew product.

6. The gummy chew product of claim 1, wherein the at least one BCAA comprises isoleucine and leucine, and the at least one mineral comprises sodium and potassium.

7. The gummy chew product of claim 6, wherein the potassium, sodium, theanine, isoleucine, leucine, and alpha-GPC are present in an amount of up to about 10% by weight combined and the gummy matrix is present in an amount of from about 90 to about 99% by weight, all based on the total weight of the gummy chew product.

8. The gummy chew product of claim 7, wherein the potassium is present in an amount of from about 0.01 to about 1% by weight, the sodium is present in an amount of from about 0.01 to about 1% by weight, the alpha-GPC is present in an amount of from about 0.2 to about 0.8% by weight, the isoleucine is present in an amount of from about 0.01 to about 1% by weight, the leucine is present in an amount of from about 0.1 to about 2% by weight, and the theanine is present in an amount of from about 0.01 to about 0.2% by weight, all based on the total weight of the gummy chew product.

9. The gummy chew product of claim 1, wherein the gummy matrix comprises a natural sweetener, a gelling agent, and water.

10. The gummy chew product of claim 9, wherein the gelling agent comprises pectin.

11. The gummy chew product of claim 9, wherein the natural sweetener comprises a sugar alcohol.

12. The gummy chew product of claim 11, wherein the sugar alcohol comprises maltitol, sorbitol, or a combination thereof.

13. The gummy chew product of claim 9, wherein the gummy matrix further comprises an acidity regulator.

14. The gummy chew product of claim 13, wherein the acidity regulator comprises malic acid, citric acid, or a combination thereof.

15. The gummy chew product of claim 1, wherein the gummy chew product further comprises at least one component selected from the group consisting of flavorants, colorants, glazing agents, and any combination thereof.

16. The gummy chew product of claim 15, wherein the gummy chew product further comprises a colorant, wherein the colorant comprises carmine.

17. The gummy chew product of claim 15, wherein the gummy chew product further comprises a glazing agent, wherein the glazing agent comprises carnauba wax, vegetable oil, or a combination thereof.

18. The gummy chew product of claim 1, wherein the gummy chew product further comprises potassium citrate.

19. The gummy chew product of claim 1, wherein the gummy chew product further comprises sodium citrate, sodium chloride, or a combination thereof.

20. The gummy chew product of claim 1, wherein, per 2 gram serving of the gummy chew product, potassium is present in an amount of from about 2 to about 15 mg, sodium is present in an amount of from about 2 to about 15 mg, alpha-GPC is present in an amount of from about 5 to about 15 mg, isoleucine is present in an amount of from about 15 to about 25 mg, leucine is present in an amount of from about 30 to about 50 mg, and theanine is present in an amount of from about 1 to about 5 mg.

21. A packaged product comprising a sealed package and a serving of the gummy chew product of claim 1 contained within the sealed package, wherein the serving of the gummy chew product is present in an amount in the range of from 50 to 150 grams and wherein the gummy chew product comprises a plurality of pieces.

22. The packaged product of claim 21, wherein the serving of the gummy chew product provides no more than 400 calories per 100 grams of gummy chew product.

23. A method of improving muscle function and recovery in an individual before, during, or after a physical activity, comprising administering the gummy chew product of claim 1 to the individual before the physical activity, during the physical activity, or after the physical activity.

24. The method of claim 23, wherein the gummy chew product is administered to the individual at least 30 minutes before the physical activity.

25. The method of claim 23, wherein the gummy chew product is administered to the individual within 1 hour after the physical activity is completed.

26. A method of providing cognitive enhancement in an individual before, during, or after a physical or mental activity, comprising administering the gummy chew product of claim 1 before the physical or mental activity, during the physical or mental activity, or after the physical or mental activity.

27. The method of claim 26, wherein the gummy chew product is administered to the individual at least 30 minutes before the physical or mental activity.

28. The method of claim 26, wherein the gummy chew product is administered to an individual within 1 hour after the physical or mental activity is completed.

29. A method of replenishing lost electrolytes comprising administering the gummy chew product of claim 1 to an individual in need thereof.
